(19) United States
(12) Patent Application Publication
(10) Pub. No.: US 2016/0160667 A1
(43) Pub. Date: Jun. 9, 2016

(54) DISCOURAGER SEAL FOR A TURBINE ENGINE

(71) Applicant: General Electric Company, Schenectady, NY (US)

(72) Inventors: Joe Timothy Brown, Simpsonville, SC (US); Elizabeth Angelyn Fadde, Greenville, SC (US); Sivaraman Vedhagiri, Greer, SC (US)

(21) Appl. No.: 14/540,730

(22) Filed: Nov. 13, 2014

(51) Int. Cl. F01D 9/02; F02C 7/28; F02C 3/14; F01D 9/04; F02C 3/04

(52) U.S. Cl. CPC F01D 9/023; F01D 9/04; F02C 3/04; F02C 3/14; F02C 7/28; F05D 2220/32; F05D 2240/128; F05D 2240/55; F05D 2300/10

(57) ABSTRACT

A sealing assembly for a turbine engine includes a first stationary component. Also included is a second stationary component, wherein the first stationary component and the second stationary component define a gap therebetween. Further included is a discourager seal in contact with at least one of the first stationary component and the second stationary component, the discourager seal having a lip portion disposed within the gap to reduce a fluid flow through the gap.

### BACKGROUND OF THE INVENTION

The subject matter disclosed herein relates to turbine systems and, more particularly, to a sealing assembly having a discourager seal for a turbine engine.

Gas turbines generally include a compressor, a combustor, one or more fuel nozzles, and a turbine. Air enters the gas turbine through an air intake and is compressed by the compressor. The compressed air is then mixed with fuel supplied by the fuel nozzles. The air-fuel mixture is supplied to the combustor at a specified ratio for combustion. The combustion generates pressurized exhaust gases, which drive blades of the turbine.

The combustor includes a transition piece for confining and directing flow of combustion products from the combustor to the first stage nozzle ring. The transition piece includes a forward end and an aft end. Located near the interface of the transition piece and the first stage nozzle ring are a radially inner and outer cavity. Exhaust gas flows through the transition piece at relatively high temperatures, therefore components located within the cavities are subject to thermal distress from hot gas ingestion. To reduce the temperature of the hardware in this cavity, cooling holes or apertures are typically provided in order to supply a cooling flow to the cavity. However, the cooling flow tends to leak through a gap between the transition piece and the stage one nozzle ring and the hot gases tend to be ingested into the cavities, thereby requiring more cooling flow to be used, thereby detracting from the overall efficiency of the gas turbine engine.

### BRIEF DESCRIPTION OF THE INVENTION

According to one aspect of the invention, a sealing assembly for a turbine engine includes a first stationary component. Also included is a second stationary component, wherein the first stationary component and the second stationary component define a gap therebetween. Further included is a discourager seal in contact with at least one of the first stationary component and the second stationary component, the discourager seal having a lip portion disposed within the gap to reduce a fluid flow through the gap.

According to another aspect of the invention, a gas turbine engine includes a compressor section. Also included is a combustor section having a transition piece operatively coupled to the turbine section. Further included is a turbine section having a first stage nozzle ring disposed proximate the transition piece, wherein the transition piece and the first stage nozzle ring define a gap therebetween. Yet further included is a discourager seal in contact with at least one of the transition piece and the first stage nozzle ring, the discourager seal disposed within the gap to reduce leakage of a purge flow into a hot gas path of the turbine section and to reduce ingestion of a hot gas flow of the hot gas path into a radially inner cavity.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is an enlarged sectional view of section A of FIG. 1 illustrating a sealing assembly according to a first embodiment;

FIG. 3 is a perspective view of the sealing assembly according to the embodiment of FIG. 2;

FIG. 4 is an enlarged sectional view of section A of FIG. 1 illustrating a sealing assembly according to a second embodiment; and

FIG. 5 is a perspective view of the sealing assembly according to the embodiment of FIG. 4.

The detailed description explains embodiments of the invention, together with advantages and features, by way of example with reference to the drawings.

### DETAILED DESCRIPTION OF THE INVENTION

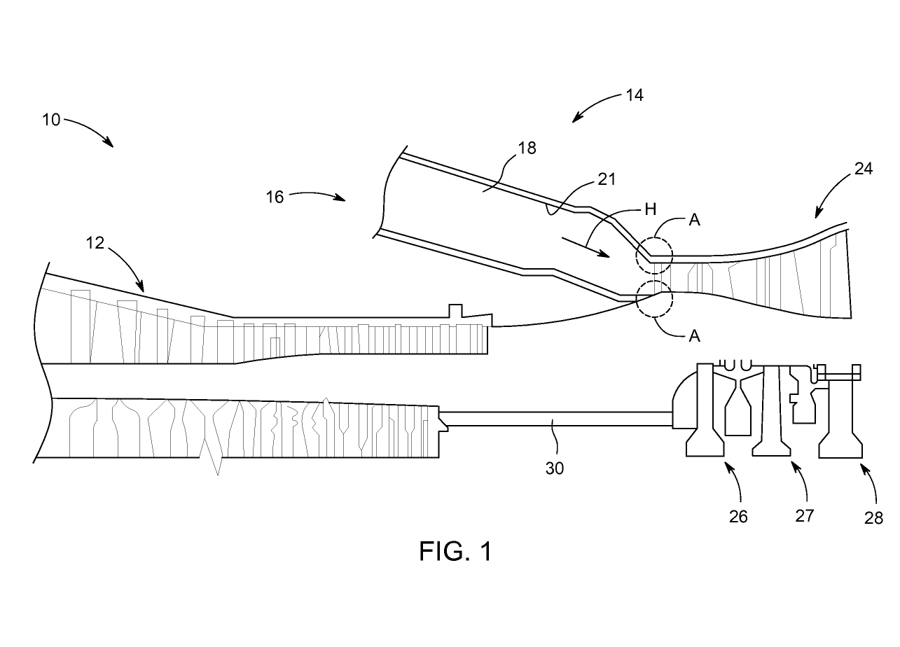

Referring to FIG. 1, a turbine system, such as a gas turbine engine 10, constructed in accordance with an exemplary embodiment of the present invention is schematically illustrated. The gas turbine engine 10 includes a compressor section 12 and a plurality of combustor assemblies arranged in a can annular array, one of which is indicated at 14. The combustor assembly is configured to receive fuel from a fuel supply (not illustrated) through at least one fuel nozzle and a compressed air from the compressor section 12. The fuel and compressed air are passed into a combustor chamber 18 defined by a combustor liner 21 and ignited to form a high temperature, high pressure combustion product or air stream that is used to drive a turbine section 24. The turbine section 24 includes a plurality of stages 26-28 that are operationally connected to the compressor 12 through a rotor structure 30 (also referred to as a shaft).

In operation, air flows into the compressor 12 and is compressed into a high pressure gas. The high pressure gas is supplied to the combustor assembly 14 and mixed with fuel, for example natural gas, fuel oil, process gas and/or synthetic gas (syngas), in the combustor chamber 18. The fuel/air or combustible mixture ignites to form a high pressure, high temperature combustion gas stream, which is channeled to the turbine section 24 and converted from thermal energy to mechanical, rotational energy. The combustor assembly 14 includes a transition piece 32 for transporting a hot gas stream H from a combustor can to a first stage nozzle ring 34 of the turbine section 24.

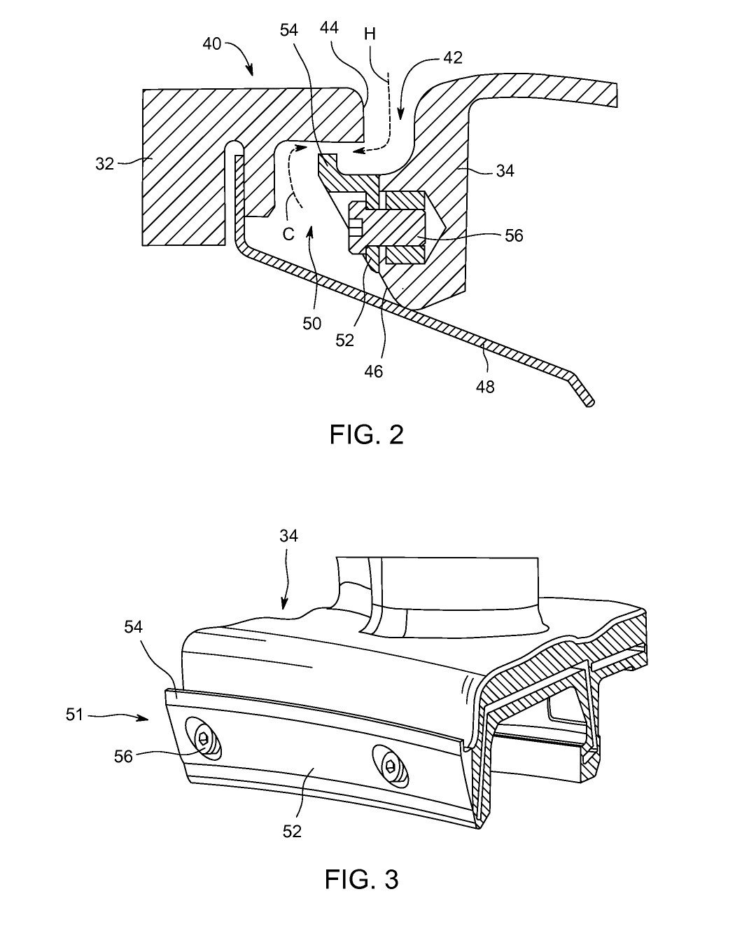

Referring now to FIGS. 2 and 3, a sealing assembly 40 is illustrated according to a first embodiment. The sealing assembly 40 may be used in conjunction with a turbine system, such as the gas turbine engine 10, but it is to be appreciated that the sealing assembly 40 may be used to seal spaces between stationary objects in numerous alternative systems. The illustrated environment depicts the sealing assembly 40 located within a gap 42 defined by an aft end 44 of the transition piece 32 and a forward end 46 of the first stage nozzle ring 34. These are substantially stationary components that move relative to each other during different operating conditions of the gas turbine engine 10. The gap 42 may vary in distance based on the different operating conditions. For example, the gap 42 is at its largest during a typical transient time point in the operation of the gas turbine engine 10 that leads to ingestion of the hot gas stream H.

Although the sealing assembly 40 is described herein and illustrated as being disposed between the transition piece 32 and the first stage nozzle ring 34, it is to be understood that the sealing assembly 40 may be disposed between any stationary components, such as a first stationary component and a second stationary component, located anywhere in the gas turbine engine 10 where leakage of a fluid is a concern.

The location of the sealing assembly 40 between the transition piece 32 and the first stage nozzle ring 34 is particularly beneficial due to the need to protect a main combustion seal 48 located within a radially inner cavity 50 from creep failure or other detrimental effects attributed with thermal stress. The radially inner cavity 50 is provided a cooling flow C to cool the components located therein and to purge any hot gas ingested into the radially inner cavity 50, thereby providing a fluid barrier to the hot gas stream H.

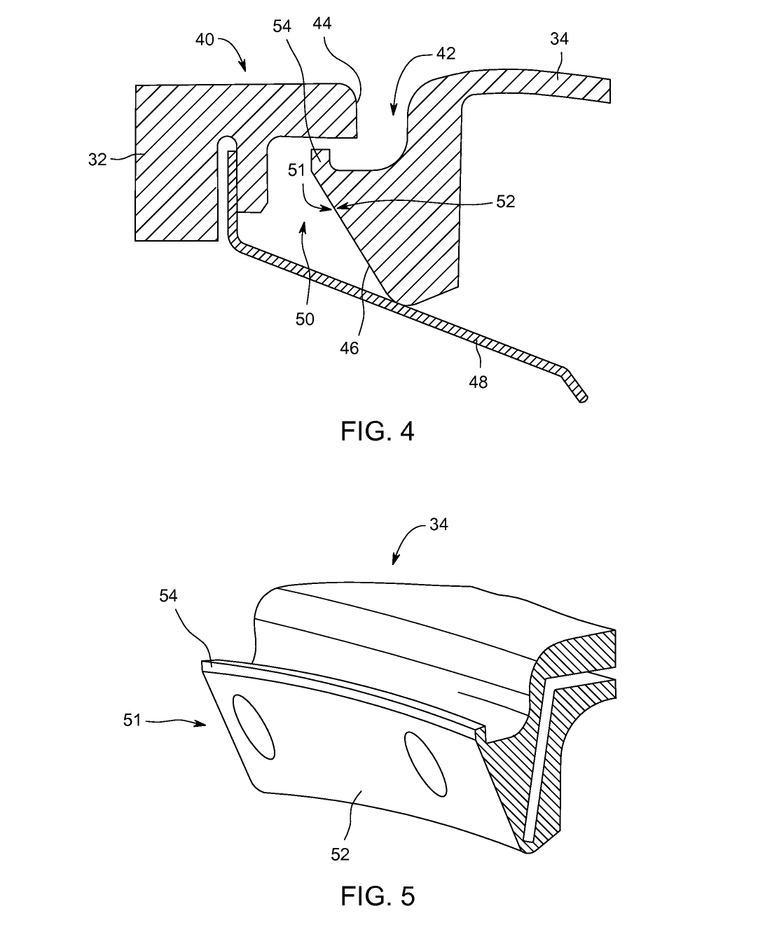

The sealing assembly 40 includes a discourager seal 51 having a main body portion 52 and a lip portion 54 extending therefrom. Generally, a discourager seal refers to a generally circular ring which has one or more flange segments for attachment to a structure and for sealing a region, as will be described in detail below. The main body portion 52 is in contact with the first stage nozzle ring 34. In the illustrated embodiment of FIGS. 2 and 3, the main body portion 52 is operatively coupled to the first stage nozzle ring 34. Exemplary manners in which operative coupling may be made include securing the main body portion 52 to the first stage nozzle ring 34 with a mechanical fastener 56, welding the components together, and brazing the components together, although other suitable joining processes may be employed. Alternatively, the main body portion 52 may be integrally formed with the first stage nozzle ring 34, such as a cast-in feature of the nozzle, as shown in the second embodiment of the sealing assembly 40 of FIGS. 4 and 5.

Irrespective of the precise manner in which the main body portion 52 is in contact with the first stage nozzle ring 34, the discourager seal 51 may be formed of any material suitable for being disposed in the operating environment of the radially inner cavity 50 proximate the hot gas stream H. Additionally, the discourager seal 51 may be formed from machined bar stock and/or formed sheet metal to obtain the desired shape of the discourager seal 51.

Although illustrated and described herein as being in contact with the first stage nozzle ring 34, the discourager seal 51 may be in contact with the transition piece 32. Specifically, the main body portion 52 of the discourager seal 51 may be integrally formed with the transition piece 32 or operatively coupled to the transition piece 32 in any of the manners described above in conjunction with the embodiments associated with the main body portion 52 in contact with the first stage nozzle ring 34.

The discourager seal 51 is shown to be spaced from at least one of the stationary components, but it is to be appreciated that during certain stages of operation of the gas turbine engine 10, the lip portion 54 may be in contact with the stationary component that is not in contact with the main body portion 52.

It is to be further appreciated that the embodiments of the sealing assembly 40 described herein may be employed proximate a radially inner portion and/or a radially outer portion of the gas path of the gas turbine engine 10, as depicted with reference character A in FIG. 1. In other words, the inner and/or outer diameter of the gas path may benefit from the embodiments of the sealing assembly 40.

Advantageously, the discourager seal protects the combustion and turbine nozzle components located within or near the radially inner cavity 50 from ingestion of the hot gas stream H, thereby reducing damage of these components during operation of the gas turbine engine 10 and improving durability. By reducing ingestion of the hot gas stream H into the radially inner cavity 50, the overall efficiency of the gas turbine engine 10 is improved based on a reduced need for cooling flow to the radially inner cavity 50.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A sealing assembly for a turbine engine comprising:
a first stationary component;
a second stationary component, wherein the first stationary component and the second stationary component define a gap therebetween; and
a discourager seal in contact with at least one of the first stationary component and the second stationary component, the discourager seal having a lip portion disposed within the gap to reduce a fluid flow through the gap.

2. The sealing assembly of claim 1, wherein the first stationary component comprises a transition piece of a combustion section and the second stationary component comprises a stage one nozzle ring of a turbine section.

3. The sealing assembly of claim 2, wherein the discourager seal is integrally formed with the stage one nozzle ring.

4. The sealing assembly of claim 2, wherein the discourager seal is operatively coupled to the stage one nozzle ring with a mechanical fastener.

5. The sealing assembly of claim 2, wherein the discourager seal is welded to the stage one nozzle ring.

6. The sealing assembly of claim 2, wherein the discourager seal is brazed to the stage one nozzle ring.

7. The sealing assembly of claim 2, wherein the discourager seal comprises formed sheet metal.

8. The sealing assembly of claim 2, wherein the discourager seal comprises machined bar stock.

9. The sealing assembly of claim 2, wherein the discourager seal is integrally formed with the transition piece.

10. The sealing assembly of claim 2, wherein the discourager seal is operatively coupled to the transition piece with a mechanical fastener.

11. The sealing assembly of claim 2, wherein the discourager seal is welded to the transition piece.

12. The sealing assembly of claim 2, wherein the discourager seal is brazed to the transition piece.

13. The sealing assembly of claim 1, wherein the discourager seal comprises formed sheet metal.

14. The sealing assembly of claim 1, wherein the discourager seal comprises machined bar stock.

15. A gas turbine engine comprising:
a compressor section;
a combustor section having a transition piece operatively coupled to the turbine section;
a turbine section having a stage one nozzle ring disposed proximate the transition piece, wherein the transition piece and the stage one nozzle ring define a gap therebetween; and
a discourager seal in contact with at least one of the transition piece and the stage one nozzle ring, the discourager seal disposed within the gap to reduce leakage of a purge flow into a hot gas path of the turbine section and to reduce ingestion of a hot gas flow of the hot gas path into a radially inner cavity.

16. The gas turbine engine of claim 15, wherein the discourager seal is integrally formed with the stage one nozzle ring.

17. The gas turbine engine of claim 15, wherein the discourager seal is operatively coupled to the stage one nozzle ring.

18. The gas turbine engine of claim 15, wherein the discourager seal is integrally formed with the transition piece.

19. The gas turbine engine of claim 15, wherein the discourager seal is operatively coupled to the transition piece.

20. The gas turbine engine of claim 15, wherein the discourager seal includes a lip portion.
